(19) United States
(12) Patent Application Publication
(10) Pub. No.: US 2008/0086066 A1
(43) Pub. Date: Apr. 10, 2008

(54) Neuro-muscular pressure point messager

(76) Inventor: Mary M. Munday, Houston, TX (US)

Correspondence Address: JAMES L. JACKSON;James L. Jackson, P.C., 10723 Sugar Hill Dr., Houston, TX, 77042, US

(21) Appl. No.: 11/998,273

(22) Filed: Nov. 29, 2007

Related U.S. Application Data
(63) Continuation-in-part of application No. 11/011,386, filed on Dec. 14, 2004.

(51) Int. Cl. A61H 39/04

(52) U.S. Cl. 601/135

(57) ABSTRACT

A neuro-muscular pressure point massage system for personal use by a user for massaging desired areas of the body of the user. A pair of elongate generally rigid structural members each have a plurality of massager mounts situated along the length thereof. End portions of the structural members are connected by a chain-like connector maintaining omnidirectional articulated connection of the elongate structural members and permits the structural members to be used in assembly and separated for independent use. The chain-like connector has a releasable link to permit selective separation of the structural members. Several massage elements are removably mounted to at least one massager mount and are oriented for selective massaging contact with the body of the user when the structural members are manually manipulated. A hand-held massage attachment that is releasable from the structural members and has number of massage projections oriented for manually applied selective massaging contact with the body of the user.

### RELATED PROVISIONAL APPLICATION

Applicant hereby claims the benefit of U.S. Provisional Patent Application No. 60/531,072, filed on Dec. 19, 2003 by Mary M. Munday and entitled “Nuero-Muscular Pressure Point Massager”.

### RELATED NON-PROVISIONAL APPLICATION

This a continuation-in-part of U.S. Non-Provisional patent application Ser. No. 11/011,386 of Mary M. Munday, filed Dec. 14, 2004 and entitled “Nuero-muscular Pressure Point Massager”.

### BACKGROUND OF THE INVENTION

### Field of the Invention

This invention relates generally to the field of neuro-muscular pressure point massage treatment which is ordinarily accomplished by a trained and licensed massage specialist in a specialists office environment and which requires a patient or subject to set an appointment and make a special visit for treatment. More specifically, the present invention concerns neuro-muscular pressure point massage treatment apparatus which is used by means of self treatment, permitting the user to accomplish pressure point massage treatment for neuro-muscular relief for himself or herself without necessitating a special visit with a trained and licensed massage specialist. Even more specifically the neuro-muscular pressure point massage treatment apparatus of the present invention is of light-weight and portable nature, permitting users to use the apparatus at home or to transport it in conventional luggage during travel, for personal use in hotels and other places to provide relief of persistent muscle pain caused by muscle tightness resulting from a wide variety of factors.

### SUMMARY OF THE INVENTION

It is a feature of the present invention to provide novel neuro-muscular pressure point massage treatment apparatus that enables a person experiencing persistent muscle pain caused by muscle tightness to conduct self-treatment for immediate relief of the neuro-muscular pain rather than necessitating scheduling an appointment for treatment by a massage specialist.

It is another feature of the present invention to provide novel neuro-muscular pressure point massage treatment apparatus that can easily be used at home or can be easily transported so that it will be available for immediate use during travel.

It is an even further of the present invention to provide novel neuro-muscular pressure point massage treatment apparatus that incorporates a number of pressure point massaging components that can be used in assembly with structural components of the apparatus or can be disassembled and used separately, thereby providing the user with the capability for accomplishing a wide variety of pressure point massage treatments.

It is also a feature of the present invention to provide novel neuro-muscular pressure point massage treatment apparatus that incorporates a pair of elongate, generally rigid structural members that are releasably connected at one of the ends thereof by means of a chain-like connection having a releasable link, permitting the structural members to be separated for individual use and permitting the structural members to be employed as levers permitting massage fingers or heads removably mounted at a selected location along the length of one or both of the structural members to be applied to pressure points of the body with as much or little force as is needed for leveraged pressure point massage treatment.

It is also a feature of this invention to provide neuro-muscular massage apparatus that is adapted for efficient self-use and which incorporates a pair of elongate structural members to which can be mounted a number of differing massage attachments for storage and transportation to ensure that the attachments remain in unitary assembly with the structural members and do not tend to become separated and lost.

It is another feature of the present invention to provide novel neuro-muscular pressure point massage treatment apparatus that employs a pair of elongate, generally rigid structural members each having multiple holes some incorporating retaining pins and some releasably receiving massage head and finger devices which permit the structural members to be releasably mounted in substantially immoveable assembly for storage or travel and permitting massage heads and fingers to be releasably secured to the structural members for storage and transportation.

It is also a feature of this invention to provide neuro-muscular massage apparatus that incorporates a pair of elongate structural members having a relatively moveable connection system which loosely connects one of the ends of each of the structural members and ensures relative omnidirectional movement and positioning of the structural members, thus providing the user with the capability for establishing a wide variety of structural member positions enabling the user to conduct a wide variety of neuro-muscular massage activities on various parts of the user's body.

Briefly, a neuro-muscular pressure point massage system is provided for personal use by a user for massaging desired areas of the body of the user to accomplish neuro-muscular pressure point massage treatment. A pair of elongate generally rigid structural members each have a plurality of massager mounts situated along the length thereof. These massager mounts are typically in the form of holes to releasably receive the mounting pins or dowels of massage attachment devices, thus providing for storage of the massage head and finger devices and to permit the massage attachment devices to be selectively positioned along the length of the structural members as may be necessary for desired massage treatment of the pressure points of the muscles. A connector element in the form of a short chain-like structure establishes releasable omnidirectional articulated connection of the elongate generally rigid members. The chain-like structure incorporates a separable connector link that permits the rigid structural members to be used in assembly or separated for independent use.

At least one massage attachment having at least one massage projection is removably assembled to at least one massager mount and is oriented for selective massaging contact with the body of the user. Each of the massage projections has a free extremity of a configuration for accomplishing predetermined pressure point massage treatment of a body region of desired size and shape. A number of massage attachments are provided, each having a desired configuration and dimension for specific pressure point treatment. Each massage attachment is provided with means for mounting at a desired position along the length of one of the elongate structural members. Preferably at least one of the elongate structural members defines multiple mounting holes that are spaced along the length thereof. The massage attachments are each provided with mounting pins that are inserted within a selected mounting hole with a releasable friction fit to support the massage attachment in a desired position for effective use. The user will simply selected a desired massage attachment and position it as desired along the length of the structural member. Then, by manipulating the structural members in lever-like fashion, using a part of the body, the other structural member or another object as a fulcrum, the body contacting portion of the massage attachment can be applied to a specific typically small region or point of the body and can be moved back and forth if desired to apply desired force to the selected body point simply by moving one or both of the structural members. This neuro-muscular pressure point massaging movement will relieve muscle tightness and reduce muscle pain by causing the painful muscle pressure point to become relaxed. The massage attachments can be in a wide variety of forms, some having small rounded or pointed ends and some having broad ends and some having multiple massage projections.

When the neuro-muscular pressure point massage apparatus is to be stored or transported it is desired to provide for maintaining all of the various parts and attachments of the apparatus in unitary assembly so that some of the components will not become separated and lost. Accordingly, the elongate structural members are provided with multiple attachment mounts so that all of the attachments can be simultaneously and releasably secured to the structural members.

For massaging certain body areas such as the hands, palms and feet, a hand held massager head defines at least one massager mount, typically in the form of a mounting pin. The mounting pin permits the hand held massaged to be mounted to one of the elongate structural members which not in use, so that it will not likely be misplaced and lost. For use, the hand held massager is separated from the elongate structural member by simply pulling its mounting pin from a mounting hole. The hand held massager is then manually applied to the user's body for massage treatment. It can then be reassembled to an elongate structural member to prevent it from becoming lost. A number of massage projections are selectively and releasably assembled singly or in groups to the massager mount and are oriented for selective massaging contact with the body of the user.

One of the elongate structural members is provided with a plurality of mounting pins that are fixed at spaced locations along the length thereof. The opposite structural member is provided with mounting holes which receive the mounting pins in a releasable friction fit. When the mounting pins of one structural member are inserted within respective mounting holes of the other structural member the structural members will be releasably retained in side by side assembly.

With one of the elongate structural members separated from the other by releasing a quick-link device of the short chain-like connector the structural member may be hung from a wall mounting device such as a suction cup having a hook, a wall hook or nail or simply hung from a wall support and stabilized by means of an adjustable lanyard. A selected massage element will be mounted at a selected location along the length of the structural member to be engaged by a user standing on a floor and leaning toward the wall support. With the massage apparatus so supported and stabilized, the user is able to accomplish efficient neuro-muscular massage simply by manipulating or adjusting the positions of the user's body while a selected neuro-muscular point or region of the user's body is in massaging engagement with a selected massage attachment.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the preferred embodiment thereof which is illustrated in the appended drawings, which drawings are incorporated as a part hereof.

It is to be noted however, that the appended drawings illustrate only a typical embodiment of this invention and are therefore not to be considered limiting of its scope, for the invention may admit to other equally effective embodiments.

In the Drawings:

FIG. 1 is a longitudinal sectional view showing two elongate structural members mounted in releasable assembly by means of mounting pins fixed to one structural member and being received by releasable friction fit within mounting holes of the other structural member;

FIG. 2 is a longitudinal sectional view similar to that of FIG. 1 and showing the released and separated positions of the elongate structural members and by exploded illustration further showing several massage heads and fingers in position for being selectively releasably mounted to one of the multiple mounting holes of a structural member;

FIG. 3 is a sectional view taken along line 3-3 of FIG. 1;

FIG. 4 is an elevational view of one of the connection mount members 104 showing its components in detail;

FIG. 5 is an elevation view showing the releasable fastener link which is employed for releasable connection of the structural members in relatively moveable omnidirectional relation;

FIG. 6 is an elevational pictorial illustration of one of many arrangements for use of the neuro-muscular pressure point massage apparatus of the present invention;

FIG. 7 is an elevational view showing the neuro-muscular pressure point massage apparatus of the present invention; and

FIG. 8 is an elevational view showing one of the elongate structural members separated from the other and supporting a neuro-muscular pressure point massage attachment and facilitating self use by manual manipulation of the structural member in lever-like fashion.

### DETAILED DESCRIPTION OF THE INVENTION

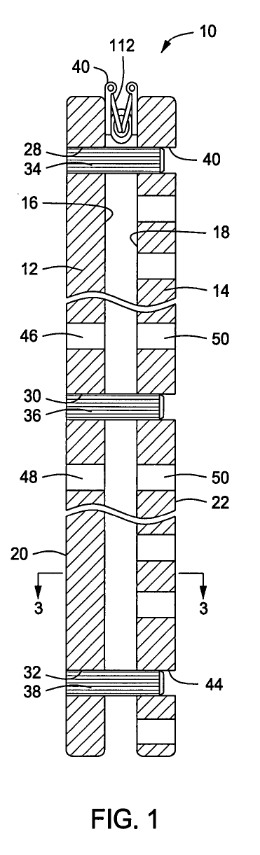

Referring now to the drawings and first to FIG. 1, a neuro-muscular pressure point massager device constructed according to the principles of the present invention is shown generally at 10 and has two elongate structural members 12 and 14. The structural members preferably have a length of 24 inches for efficiency of use, handling, transportation and storage but may be of lesser or greater length without departing from the spirit and scope of the present invention. The elongate structural members are preferably composed of wood material, such as pine, or hard wood such as oak, walnut, maple, but in the alternative may be composed of plastic material, glass, metal, acrylic or any combination of these materials. Since the structural members will be used in the form of levers to apply a wide range of desired forces to parts of the user's body, it is necessary that they be composed of materials that will not break under the maximum expected mechanical stress. When the structural members and/or the massage attachments are composed of wood it is desirable that the apparatus be kept dry, since moisture can change the friction fit of certain components.

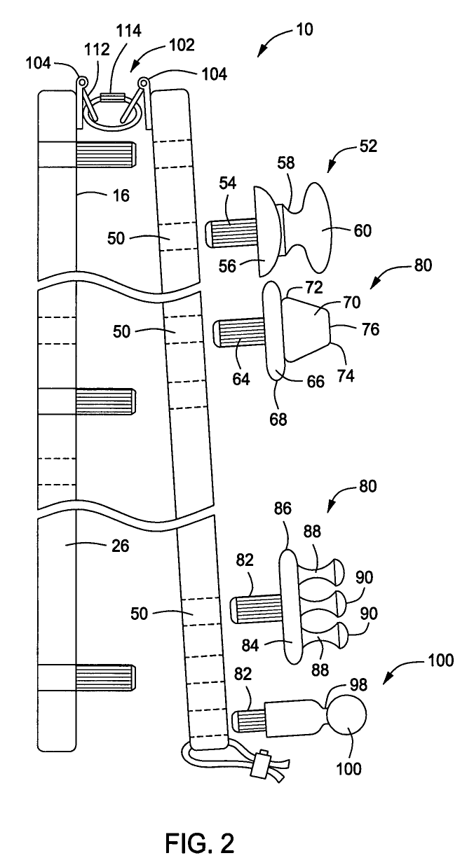

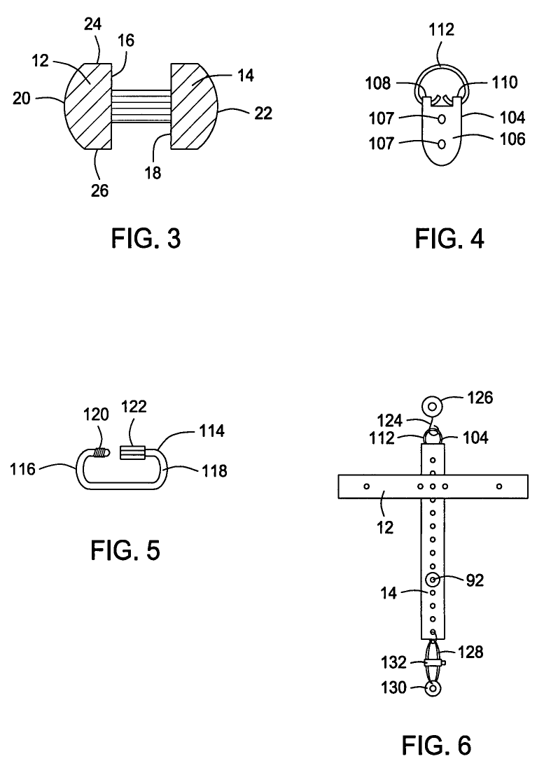

The elongate structural members 12 and 14 preferably have a cross-sectional configuration as shown in the sectional view of FIG. 3. Preferably the structural members 12 and 14 have a thickness of about ¾ inch and a length of about 24 inches, but it should be understood that this preferred thickness and length is not intended to be limiting with respect to the present invention. Neuro-muscular massage apparatus having structural members of greater or less thickness and greater or less length may be employed as well. The structural members define substantially planar elongate surfaces 16 and 18 that are oriented to face one another and elongate convex surfaces 20 and 22 that also extend substantially the entire length of the structural members. The elongate structural members are each configured to define substantially straight opposed edge surfaces such as shown at 24 and 26 in FIGS. 2 and 3. This feature permits the elongate structural members to be comfortably held in the hands of the user during personal use of the apparatus for neuro-muscular pressure point massaging.

To permit the elongate structural members to be secured in substantially immoveable relation with one another, such as for storage or transportation, structural member 12 defines three dowel or peg holes 28, 30 and 32. Dowels or peg holes 28 and 32 are located at end portions of the structural member and dowel receptacle hole 30 being centered between holes 28 and 32. End portions of three dowel or peg members 34, 36 and 38 are fixed within each of these three dowel or peg holes. The ends of the dowels may be tightly and immovably retained within the holes by friction fit or may be secured within the holes by means of cement or any suitable bonding agent. Portions of the dowel or peg members extend well beyond the elongate substantially planar surface 16 of the elongate structural member 12 and have tapered ends serving as guides to permit the dowel or peg members to be guided into corresponding dowel receiving holes 40, 42 and 44 of the elongate structural member 14. The dowels are easily inserted into the corresponding dowel holes and a small manual pushing force is applied to establish a releasable friction fit of the dowels within the holes, thus causing both elongate structural members to be retained in unitary assembly as shown in FIG. 1 until such time as they are pulled apart by application of manual force. This condition of unitary assembly is employed when the massager device is to be stored or transported and may also be employed to characterize the apparatus for particular neuro-muscular pressure point massaging techniques.

The elongate structural member 12 preferably defines two massage attachment mounting holes 46 and 48 being located on opposite sides of the centrally located fixed dowel 36. These two massage attachment mounting holes are preferably located with their centers spaced about one inch from the center of the centrally located dowel receptacle hole 30. These massage attachment mounting holes are adapted to releasably receive the dowels or pegs of any of a number of massaging attachment members discussed in detail below, thus permitting the user to characterize the apparatus for particular massaging techniques. Additional massaging attachment mounting holes may be provided in the elongate structural member 12 as desired by the user of the massaging apparatus to permit desired location of other massaging attachments at desired locations along the length thereof.

Elongate generally rigid structural member 14 typically has the same cross-sectional configuration as shown in FIG. 3 and has multiplicity of substantially equally spaced massage attachment mounting holes along its length. If desired, the mounting holes 50 may be of the same dimension as the corresponding dowel holes 40, 42 and 44, such as being of about 12 inch diameter, though they may be of larger or smaller dimension without departing from the spirit and scope of the present invention. When elongate structural members having lengths of 24 inches are employed there will preferably be 22 holes located along the length of structural member 14, with three of the holes being the dowel receiving holes or receptacles 28, 30 and 32. Two of the dowel receiving holes or receptacles are located with the centers thereof about 2 inches from the respective ends of the structural member 14. It should be borne in mind however that the spacing of the end dowel receptacle holes may be less or greater than 2 inches without departing from the spirit and scope of the present invention.

Various massage attachment elements are intended to be selectively mounted at selected locations along the length of the elongate structural member 14 or to be selectively located on the elongate structural member 12 to be used to apply mechanical force to different sized and differently located regions of the user's body for neuro-muscular pressure point massage therapy. When such massage treatment is done in the office environment of a massage therapy specialist, the specialist will typically use parts of the specialists hands, fingers and elbows to apply manual force to selected pressure points of the patient's body for selected periods of time as appropriate to cause physiological release of muscle tension. Using a finger will allow the specialist to apply manual force to a rather small area of the body. The manual force or pressure of a thumb of the specialist will apply force or pressure to a larger area. And the use of the elbow of the specialist permits application of manual force or pressure to an even greater sized region of the patient's body. It is desired therefore to provide replaceable massage attachments that are configured to simulate a finger, thumb or elbow so that the user can employ these attachments to apply mechanical force or pressure to particular sized regions of his or her body. In some cases a therapist will use multiple fingers or knuckles in a manner to engage a part of a patient's body and apply force in a twisting fashion so that certain muscles receive stretching activity as well as pressure point massage activity. It is also desired to provide the elongate structural member 14 with an attachment that enables the user to also provide this type of treatment of particular muscles of his or her body.

One such replaceable attachment, typically referred to as the “palm” attachment is shown generally at 52 in the exploded illustration of FIG. 2 and is provided with a fixed mounting dowel 54 that is adapted to be inserted into any one of the multiple massage attachment mounting holes 50 of the elongate structural member 14. The palm attachment 52 has a circular stabilizing flange 56 and defines an intermediate reduced diameter section 58. A rather large, broad and smoothly and gently curved annular patient contact portion 60 defines the free end of the palm attachment and is employed to apply force or mechanical pressure to fairly large neuro-muscular pressure point areas of the user's body. It should also be borne in mind that the palm attachment 52 may be separated from a structural member and used independently by manually pressing it against a part of the user's body.

A second pressure point massage attachment, shown generally at 62, is referred to as the “elbow” attachment. This attachment is also provided with a fixed mounting dowel 64 that is adapted to be inserted into any one of the multiple massage attachment mounting holes 50 of the elongate structural member 14. The elbow attachment 62 is provided with a circular stabilizing flange 66 having a circular outer periphery 68 of curved cross-sectional configuration. The elbow attachment 62 is provided with a patient contact element 70 that is of circular configuration and tapers from a rather large base end 72 to a patient contact end 74 that is of smaller dimension as compared with the base end. The patient contact end also defines a generally planar circular end surface 76. The generally tapered elbow attachment 62 is intended to approximate the shape and dimension of the human elbow and thereby permits the user to apply mechanical pressure or force to a region of the user's body that approximates the size and configuration of the attachment.

Another neuro-muscular pressure point therapy attachment, shown generally at 80, is known as the “muscle grabber”. The muscle grabber attachment 80, like the other neuro-muscular pressure point massage attachments, is provided with a fixed mounting dowel 82 that is inserted into one of the space mounting holes 50 to locate the grabber attachment at any suitable location along the length of the elongate structural member 14. An annular plate member 84 is mounted in fixed relation to the mounting dowel 82 and is provided with a smoothly curved outer peripheral surface 86 enabling the muscle grabber attachment to be easily and efficiently handled by a user. A plurality of muscle grabber tree members 88 are fixed to and project outwardly from the annular plate member 84 and are preferably arranged in a triangular pattern. However, it should be borne in mind that the muscle grabber tree members may be arranged in any other pattern within the spirit and scope of the present invention. The muscle grabber tree members are each of reduced intermediate diameter and define convexly curved circular patient contact surfaces 90. Though the muscle grabber attachment is intended for releasable mounting to the elongate structural member 14 so that it will not become easily separated and lost, it is intended to be separated from the structural member and used manually such as by manually pressing the grabber tree elements against the body tissue of the user and rotating or twisting it or providing laterally oriented force to achieve stretching of selected muscles. If desired however, the muscle grabber attachment may be mounted to one of the elongate structural members and used to massage or stretch certain muscles in much the same manner as the other massage attachments are used.

Another neuro-muscular pressure point therapy attachment, shown generally at 92, is known as the “thumb” attachment since it generally simulates the general size and shape of a massage therapist's thumb. This attachment is provided with a fixed mounting dowel 94 that is inserted into one of the space mounting holes 50 or into one of the mounting holes 46 and 48 of the structural member 12. The mounting dowel 94 is typically inserted or forced into a drilled hole in a generally cylindrical body 96 of the thumb attachment and may be secured immovably therein by means of a tight friction fit or by a quantity of cement or bonding agent. The thumb attachment has a base portion having a diameter of about one inch and having a length of about 1½ inches. The terminal or free end of the thumb attachment is defined by a reduced diameter section 98 which merges with a substantially spherical patient contact portion 100 that defines the free extremity or patient contact portion of the thumb attachment.

As mentioned above, the elongate structural members, with one or more selected massage attachments mounted thereon will be used as levers, bars or massage attachment positioning devices enabling the user to conduct a wide range of personal neuro-muscular massage treatment to various parts of his or her body. To permit this wide range of personally selected massage treatment one end portion of each elongate structural member is provided with means for connecting the ends in relatively moveable assembly to permit substantially omnidirectional movement of the elongate structural members one to the other while maintaining rather loose but substantially strong connection between the connected ends. To accomplish this feature, a rather short releasable chain-like connection is employed as shown generally at 102. It should be understood that other releasable connection apparatus may be employed to provide the loose connection that is need to provide for efficient use of the neuro-muscular pressure point massage treatment apparatus without departing from the spirit and scope of the present invention. For example, ends of each of the elongate structural members may be connected by a simple cord or cable. To facilitate selective release of the structural members a releasable connector link may be connected with cord or cable sections.

The short releasable chain-like connection 102 has a connection mount member 104 such as the heavy duty ring hanger shown in FIG. 4 which includes a mounting plate 106 having holes 107 to receive screws that are threaded into the respective structural member to secure the mounting plate in place on one end portion of the substantially planar elongate surfaces 16 and 18 of the structural members. The mounting plate defines a pair of spaced rolled tabs 108 and 110 that define pivot openings within which end portions of a heavy duty retainer link or ring 112 of the ring hanger are secured for pivotal or rotational movement. The heavy duty retainer link or rings 112 each receive end portions of a releasable fastener link 114 typically referred to as a quick-link. The releasable fastener link 114 is shown in its open or release condition in FIG. 5 and is generally in the form of rather flat or narrow chain link having rounded ends 116 and 118. One end portion defines a threaded section 120 that is received by internal threads of an internally threaded closure barrel member 122. When the elongate structural members 12 and 14 are to be used in combination the releasable fastener link 114 will be closed and secured by threading the closure barrel onto the threaded section 120 to its full extent. When only one of the elongate structural members 12 or 14 is intended to be used, the releasable fastener link 114 will have been opened to release one of the heavy duty retainer links or rings 112 after which the fastener link will closed while in assembly with the other of the retainer links or rings so that it will not become separated and lost and will be readily available when the ends of the structural members are again to be connected in loose omnidirectionally moveable assembly.

The neuro-muscular pressure point massage treatment apparatus of the present invention may be used in a wide variety of ways to accomplish self treatment for relief of muscle tightness. As shown in FIG. 6 the elongate structural members 12 and 14 may be connected together in the form of a cross that is defined by inserting the central dowel or peg member 36 of structural member 12 into one of the multiple holes 50 of the structural member 14. The retainer link or ring 112 of the connection mount member 104 can be engaged by a support hook member 124 of a suction cup fastener 126, assuming the apparatus is to be supported on a rather smooth vertically oriented surface such as a door or wall. A support hook of any other variety may be employed as well for support of the self employed massage apparatus. At the opposite or lower end of the elongate structural member 14 an adjustable lanyard 128 is extended through the lower most of the mounting holes 50 and is connected to another suction cup mounted connector device 130. The length of the lanyard is adjusted by a releasable keeper member 132 to tighten the lanyard for stabilization of the position of the neuro-muscular pressure point massage treatment apparatus. The apparatus will be stabilized against rotational movement by the dowel members 34 and 38 which will be disposed in contact with the flat smooth surface on which the apparatus is supported. A massage attachment, such as the thumb attachment 92 will be positioned suitably along the length of the vertically oriented structural member 14 so that the user of the apparatus can lean against the massage attachment and move the body in a manner for achieving desired muscle relief therapy.

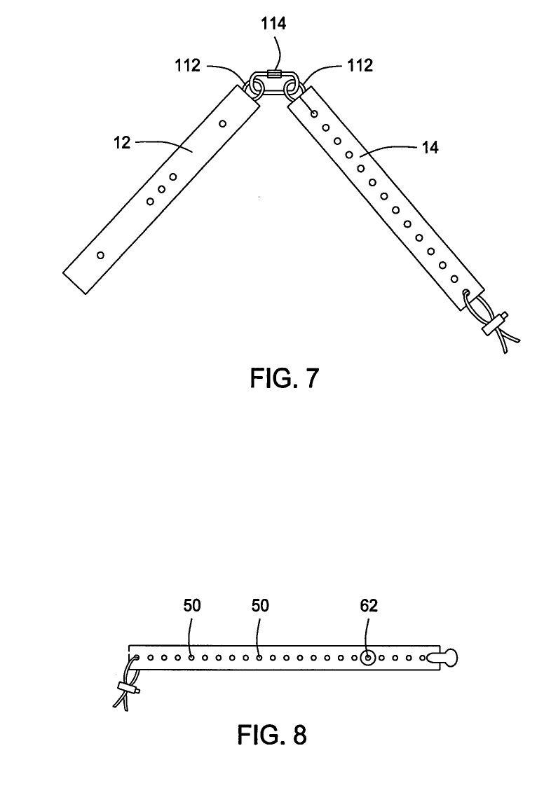

As shown in the elevational view of FIG. 7 the elongate structural members 12 and 14 are shown to be omnidirectionally movable relative to one another and the connected ends of the structural members are loosely connected and thus relatively moveable relative to one another. However the loose connection that is established by the releasable chain-like connection 102 is quite strong and will allow significant force to be applied to it without pulling apart. The releasable fastener link 114 is shown to be engaged with each of the retainer links or rings 112 of the connection mount members 104 and is closed and secured to maintain the connection in the form of a short chain-like structure. A user of the apparatus will typically grasp each of the elongate structural members and will position one of them with its massage attachment located so as to contact a desired region of the user's body. By manually manipulating the elongate structural members in the manner of levers, employing the short chain-like connection as the pivot region or fulcrum, the massage attachment can be forced against the selected body region, i.e., pressure point, to provide for release of muscle tension. The length of the structural members permits the user to easily manipulate or move the massage attachment in precision manner for applying desired mechanical force or pressure to the selected pressure point. Lateral movement can also be applied manually to one or both structural members to apply muscle stretching force as well as direct mechanical pressure. With minimal training, which can be accomplished via the use of a training manual having photographs of the apparatus in use, the user will be capable of easily achieving high quality neuro-muscular pressure point treatment.

As shown in FIG. 8 one of the elongate structural members can easily be used alone to achieve neuro-muscular pressure point massage treatment. In this case a massage attachment, such as the elbow attachment 62 can be assembled at any desired location along the length of the structural member. The user will position one end of the structural member so as to form a pivot point or fulcrum and will apply manual force to the opposite end portion of the structural member to move the massage attachment in a manner applying therapeutic massage force to a selected region of the user's body.

In view of the foregoing it is evident that the present invention is one well adapted to attain all of the objects and features hereinabove set forth, together with other objects and features which are inherent in the apparatus disclosed herein.

As will be readily apparent to those skilled in the art, the present invention may easily be produced in other specific forms without departing from its spirit or essential characteristics. The present embodiment is, therefore, to be considered as merely illustrative and not restrictive, the scope of the invention being indicated by the claims rather than the foregoing description, and all changes which come within the meaning and range of equivalence of the claims are therefore intended to be embraced therein.

I claim:

1. A neuro-muscular pressure point massage system for personal use by a user for neuro-muscular massage of desired areas of the body of the user, comprising:
first and second elongate generally rigid structural members each having a plurality of message attachment mounts situated at spaced locations along the length thereof;
a connector mechanism establishing releasable omnidirectional articulated connection of end portions of said first and second elongate generally rigid members permitting said elongate generally rigid structural members to be used with end portions thereof in assembly and permitting said elongate generally rigid structural members to be separated for independent use; and
at least one massage attachment element being removably mounted to at least one of said plurality of massager mounts of said elongate generally rigid members and being oriented for selective massaging contact with the body of the user.

2. The neuro-muscular pressure point massage system of claim 1, comprising:
said connector mechanism being a short chain-like connector having portions thereof secured to end portions of each of said elongate generally rigid structural members; and
said short chain-like connector having a releasable connector link permitting separation of said short chain-like connector.

3. The neuro-muscular pressure point massage system of claim 2, comprising:
said short chain-like connector having ring mount members secured to said end portions and each pivotally supporting a connector ring; and
said releasable connector link receiving said connector rings of each of said ring mount members and having an open condition permitting said connector rings to be assembled thereto or removed therefrom and having a closed condition securing said connector rings in connected assembly therewith.

4. The neuro-muscular pressure point massage system of claim 1, comprising:
said plurality of massage element mounts being holes formed through said elongate generally rigid structural members at locations along the length thereof; and
said at least one massage attachment having a dowel being receivable in a selected one of said holes and establishing a releasable friction fit therein retaining said at least one massage attachment in releasable assembly with a selected one of said elongate generally rigid structural members.

5. The neuro-muscular pressure point massage system of claim 1, comprising:
a lanyard extending through an end portion of one of said elongate generally rigid structural members;
an adjustable keeper member being in assembly with said lanyard and being manually manipulated for adjusting the effective length of said lanyard; and
suction cup members each adapted for releasable mounting to a smooth vertical surface and having retainer hook members, one of said suction cup members engaging a portion of said connector mechanism for support of one of said elongate generally rigid structural members and one of said suction cup members releasably engaging said lanyard; and
said adjustable keeper adjusting the length of said lanyard for stabilization of said elongate generally rigid structural member on said smooth vertical surface.

6. The neuro-muscular pressure point massage system of claim 1, comprising:
said massager mounts being a plurality of holes extending through said first and second elongate generally rigid structural members; and
said first elongate generally rigid structural member having mounting dowel members fixed thereto and projecting laterally therefrom and being selectively receivable within said holes and securing said first and second elongate generally rigid structural members in releasable assembly.

7. The neuro-muscular pressure point massage system of claim 6, comprising:
in one arrangement for personal use of said neuro-muscular pressure point massage system said second elongate generally rigid structural member being mounted substantially vertically to a smooth vertical surface;
two of said mounting dowel members being located at end portions of said first elongate generally rigid structural member and a central mounting dowel member being located centrally between said two of said mounting dowel members; and
said central mounting dowel member being mounted within a mounting hole of said first elongate generally rigid structural member and positioning said second elongate generally rigid structural member in transversely oriented relation with said first elongate generally rigid structural member with said two of said mounting dowel members positioned for rotational stabilizing engagement with said vertically oriented smooth surface.

8. A neuro-muscular pressure point massage system for personal use by a user for neuro-muscular massage of desired areas of the body of the user, comprising:
first and second elongate generally rigid structural members each having a plurality of message attachment mount holes situated at spaced locations along the length thereof;
a releasable chain-like connector connecting an end portion of each of said first and second elongate generally rigid structural members and establishing releasable omnidirectional relative movement of end portions of said first and second elongate generally rigid members permitting said elongate generally rigid structural members to be used with end portions thereof in assembly and permitting said elongate generally rigid structural members to be separated for independent use;
said releasable chain-like connector having a releasable connector link receiving said connector rings of each of said ring mount members and having an open condition permitting said connector rings to be assembled thereto or removed therefrom and having a closed condition securing said connector rings in connected assembly therewith; and
a plurality of massage attachment elements of differing configuration being removably mounted to selected massage attachment mount holes of said elongate generally rigid members and being oriented and moved by manual user manipulation of said first and second elongate generally rigid structural members for selective massaging contact with the body of the user.

9. The neuro-muscular pressure point massage system of claim 8, comprising:
said short chain-like connector having ring mount members secured to said end portions of said first and second elongate generally rigid structural members and each having a connector ring pivotally supported thereby; and
said releasable connector link receiving said connector rings of each of said ring mount members and having an open condition permitting said connector rings to be assembled thereto or removed therefrom and having a closed condition securing said connector rings in connected assembly therewith.

10. The neuro-muscular pressure point massage system of claim 8, comprising:
said first elongate generally rigid structural member having mounting dowel members fixed thereto and projecting laterally therefrom and being selectively receivable within said attachment mount holes and securing said first and second elongate generally rigid structural members in substantially immoveable releasable assembly.

11. The neuro-muscular pressure point massage system of claim 8, comprising:
in one arrangement for personal use of said neuro-muscular pressure point massage system said second elongate generally rigid structural member being mounted substantially vertically to a smooth vertical surface;
two of said mounting dowel members being located at end portions of said first elongate generally rigid structural member and a central mounting dowel member being located centrally between said two of said mounting dowel members; and
said central mounting dowel member being mounted within a mounting hole of said first elongate generally rigid structural member and positioning said second elongate generally rigid structural member in transversely oriented relation with said first elongate generally rigid structural member with said two of said mounting dowel members positioned for rotational stabilizing engagement with said vertically oriented smooth surface.

12. The neuro-muscular pressure point massage system of claim 8, comprising:
a lanyard extending through an end portion of one of said elongate generally rigid structural members;
an adjustable keeper member being in assembly with said lanyard and being manually manipulated for adjusting the effective length of said lanyard; and
suction cup members each adapted for releasable mounting to a smooth vertical surface and having retainer hook members, one of said suction cup members engaging a portion of said connector mechanism for support of one of said elongate generally rigid structural members and one of said suction cup members releasably engaging said lanyard; and
said adjustable keeper adjusting the length of said lanyard for stabilization of said elongate generally rigid structural member on said smooth vertical surface.

13. A neuro-muscular pressure point massage system for personal use by a user for massaging desired areas of the body of the user, comprising:
first and second elongate generally rigid structural members each having a plurality of message attachment mount holes situated at spaced locations along the length thereof;
a releasable chain-like connector connecting an end portion of each of said first and second elongate generally rigid structural members and establishing releasable omnidirectional relative movement of end portions of said first and second elongate generally rigid members permitting said elongate generally rigid structural members to be used with end portions thereof in assembly and permitting said elongate generally rigid structural members to be separated for independent use;
said releasable chain-like connector having a releasable connector link receiving said connector rings of each of said ring mount members and having an open condition permitting said connector rings to be assembled thereto or removed therefrom and having a closed condition securing said connector rings in connected assembly therewith; and
a plurality of massage attachment elements of differing configuration being removably mounted to selected massage attachment mount holes of said elongate generally rigid members and being oriented and moved by manual user manipulation of said first and second elongate generally rigid structural members for selective massaging contact with the body of the user;
one of said plurality of massage attachment elements being a manually handled massage element having a mounting dowel fixed thereto and adapted to be received in releasable friction fitting relation within one of said plurality of massage attachment mount holes, said manually handled massage element being removable from said first and second elongate generally rigid structural members; and
a plurality of massage projections being selectively and releasably assembled to said at least one massager mount and being oriented for selective massaging contact with the body of the user.

14. The neuro-muscular pressure point massage system of claim 13, comprising:
said short chain-like connector having ring mount members secured to said end portions of said first and second elongate generally rigid structural members and each having a connector ring pivotally supported thereby; and
said releasable connector link receiving said connector rings of each of said ring mount members and having an open condition permitting said connector rings to be assembled thereto or removed therefrom and having a closed condition securing said connector rings in connected assembly therewith.

15. The neuro-muscular pressure point massage system of claim 13, comprising:
said first elongate generally rigid structural member having mounting dowel members fixed thereto and projecting laterally therefrom and being selectively receivable within said attachment mount holes and securing said first and second elongate generally rigid structural members in substantially immoveable releasable assembly.

16. The neuro-muscular pressure point massage system of claim 13, comprising:
in one arrangement for personal use of said neuro-muscular pressure point massage system said second elongate generally rigid structural member being mounted substantially vertically to a smooth vertical surface;
two of said mounting dowel members being located at end portions of said first elongate generally rigid structural member and a central mounting dowel member being located centrally between said two of said mounting dowel members; and
said central mounting dowel member being mounted within a mounting hole of said first elongate generally rigid structural member and positioning said second elongate generally rigid structural member in transversely oriented relation with said first elongate generally rigid structural member with said two of said mounting dowel members positioned for rotational stabilizing engagement with said vertically oriented smooth surface.
